(19) United States
(12) Patent Application Publication
(10) Pub. No.: US 2015/0144685 A1
(43) Pub. Date: May 28, 2015

(54) PORTFOLIO WITH PAPER RETAINING STRUCTURE

(71) Applicant: Pablo Torre SIERRA, Mexico (MX)

(72) Inventor: Pablo Torre SIERRA, Mexico (MX)

(21) Appl. No.: 14/549,819

(22) Filed: Nov. 21, 2014

Related U.S. Application Data
(63) Continuation-in-part of application No. 12/660,811, filed on Mar. 4, 2010, now abandoned.
Application No. 12/660,811 is a continuation-in-part of application No. 10/515,971, filed on Aug. 5, 2005, now abandoned.

(51) Int. Cl. B42F 7/02

(52) U.S. Cl. CPC B42F 7/02
USPC 229/67.4

(57) ABSTRACT

A stationery article for the preservation of documents has a body, a sheet affixed directly to the lower edge and the site edge of the body so as to define a pocket, and a trapezoidal-shape fastening element having an upper portion adhered directly of the first panel at a location inwardly of the upper edge of the first panel. The fastening element has a lower portion biased toward and free of the generally planar surface of the first panel and flexibly movable away from the generally planar surface. The fastening element is suitable for holding an upper portion of the documents against the generally planar surface.

### CROSS-REFERENCE TO RELATED APPLICATIONS

The present application is a continuation-in-part of U.S. patent application Ser. No. 12/660,811, filed on Mar. 4, 2010, and entitled “Fastening Device for the Content of Portfolios”, presently pending. U.S. patent application Ser. No. 12/660,811 was a continuation-in-part of co-pending U.S. application Ser. No. 10/515,971, filed on Aug. 5, 2005, now abandoned. U.S. application Ser. No. 10/515,971 is the National Stage of International Application No. PCT/MX2002/000039, filed May 14, 2002.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to portfolios and folders. More particularly, the present invention the relates to portfolios that serve to preserve and retain documents therein. Additionally, the present invention related to portfolios wherein the positioning of the document within the portfolio is securely maintained.

2. Description of Related Art Including Information Disclosed Under 37 CFR 1.97 and 37 CFR 1.98

Articles for retaining loose leaves or files, such as briefcases and portfolios, are thoroughly well-known in the prior art. They are made in a wide variety of forms and materials, such as paper, plastic and vinyl. The plastic articles can be made of polyethylene, polypropylene and PVC.

These portfolios are commonly constructed by having a front cover and a back cover. In portfolios, a dorsal ribbon is placed between the cover which serves to form a hinge in order to allow the cover to be opened and closed and so as to permit the insertion or the removal of the documents. Conventionally, the front and back covers of such conventional portfolios are formed from planar panels with slightly larger dimensions than that of standard paper sizes used in the home or office. The dorsal ribbon is narrower and has a thickness corresponding to the number of leaves that is desired to be retained by the portfolio. In certain folders that serve to retain very few sheets of paper, the dorsal ribbon will not exist.

In the paper-retaining articles of the prior art, variety of alternatives have been proposed so as to preserve the integrity of the documents placed within such folders. These alternatives include the employment of mechanical elements such as hoops, rings, fasteners and staples. In these circumstances, the paper must be perforated in corresponding places so as to be properly retained. In other circumstances, pressure fastenings, such as paperclips and other prehensile elements are positioned on the back panel of the folder or portfolio. These pressure fastenings significantly reduce damage to the paper that is intended to be preserved. Unfortunately, they tend to leave marks at those points of contact with the paper.

Other alternatives have included the incorporation of additional panels on the interior surfaces of one of the panels of the folder. These form a support in the nature of a “lapel” or “pocket”. The paper can be introduced into such a lapel or pocket in order to be retained. These pockets can reach various heights in connection with the panel to which they are affixed. In a simple version of the concept of the use of such “lapels”, these are simple continuations of one or more ends of the panels that form the body of the folder or portfolio.

It is important to note that in all the cases referred to hereinabove, the inferior edge and at least one of the two adjacent corners of the preserved document are protected by the lapel or pocket itself. Unfortunately, the upper edge and the adjacent corners normally are free. As such, they can be subject to damage as a result of the opening and closing of the panels of the folder or portfolio. When such folders or portfolios are used, it is important to be able to take care when arranging the papers within the panels.

Several alternatives of been developed in an attempt to overcome these problems. These are shown in U.S. Pat. Nos. 4,629,349 and 6,286,752. U.S. Pat. No. 4,629,349 offers a portfolio of rings with pockets joined to the internal surfaces of the panel. Each pocket has a lapel that assures that the documents are preserved by means of pressure fastening. The material, which is flexible and transparent, conforms the pocket and is joined to the internal surfaces of the portfolio by means of thermo-sealing. In U.S. Pat. No. 6,286,752, “tongues” are offered in order to support the paper. These are simple projections from the shortest sides of one of the panels of the folder. Upon bending toward the interior of the folder, they restrict, to a certain amount, the movement of the material or paper in the interior of the folder.

It is an object of the present invention to provide a stationery article for the preservation of documents.

It is another object of the present invention provide a stationery article that assures the integrity of the documents within the interior.

It is still further object of the present invention to provide a stationery article, such as a portfolio or a folder, which avoids mechanical mistreatment produced by the action of the covers of the panels of the stationery article.

It is still a further object of the present invention to provide a stationery article which assures the physical integrity of the documents.

It is a further object of the present invention to provide a stationery article to provide an economical and effective way for the inclusion of an element suitable for obtaining such an objective.

It is still another object of the present invention to provide a stationery article which does not interfere with the view of the cover of the preserved papers.

It is still another object of the present invention to provide a stationery article in which the device or fastening element can bend without impeding the use of the article and does not obstruct the article when inserting they paper into the article.

These and other objects and advantages of the present invention will become apparent from a reading of the attached specification and appended claims.

### BRIEF SUMMARY OF THE INVENTION

The present invention is a stationery article for the preservation of documents that includes a body suitable for holding documents, a sheet affixed directly to the lower edge and directly to the side edge of the body so as to define a pocket with the generally planar surface of the first panel of the body. A trapezoidal-shaped fastening element is formed of a single ribbon of semi-rigid material.

The first panel of the body is in foldable relationship with a second panel. The first panel has a lower edge, an upper edge and a side edge extending between the upper edge and the lower edge. The first panel has a generally planar surface.

The sheet is formed of a flexible material. The sheet extends from the lower edge of the first panel toward the upper edge of the body for distance less than one-half of the distance between the lower edge and the upper edge of the first panel. The pocket is suitable for holding documents against the generally planar surface of the first panel.

The fastening element has an upper portion adhered directly to the first panel at a location inwardly of the upper edge of the first panel. The fastening element has a lower portion biased toward and free of the generally planar surface of the first panel and flexibly movable away from the generally planar surface. The fastening element is suitable for holding an upper portion of the documents against the generally planar surface. The lower portion of the fastening element has a linear edge in parallel relation to the upper edge of the first panel. The linear edge of the lower portion of the fastening element has a length less than a length of a linear edge of the upper portion of the fastening element. The generally planar surface of the first panel is uncovered in an area between the fastening element and the sheet when the documents are not positioned thereon. The fastening element has an uninterrupted surface without a fold line extending between the linear edges thereof. The fastening element is of a transparent or translucent material. The fastening element lies juxtaposed against the generally planar surface of the first panel. The fastening element is suitable for preventing the documents from moving when interposed between the fastening element and the generally planar surface. The side edge has no fastening element extending inwardly therefrom. The fastening element is entirely uncovered on a surface thereof opposite the first panel.

This foregoing Section is intended to describe, with particularity, the preferred embodiment of the present invention. It is understood that modifications to this preferred embodiment can be made within the scope of the present invention. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a perspective view of a stationery article of the prior art shown in an open position and indicating the lapel-type supporting elements.

FIG. 2 is a perspective view of the article of FIG. 1 showing the manner in which the documents are inserted into the elements of the support.

FIG. 3 is a perspective view of the article of FIG. 1 showing how the documents can suffer damage through the normal use of the stationery article.

FIG. 4 is a perspective view of the stationery article of the present invention.

FIG. 5 is a detailed view of the stationery article of FIG. 4 showing the manner in which the fastening element is positioned for use in the retention of documents.

FIG. 6 is a perspective view of a conventional stationery article similar to FIG. 5 showing the fastening element as being used in association with paper.

FIG. 7 is a perspective view of a conventional stationery articles, such as that of FIG. 5, showing the fastening element in its in-use position in an alternative modality.

FIG. 8 is a view of the stationery article of the present invention showing the device as being used with the fastening element having a lesser length than that of the edge.

FIG. 9 is a perspective view of the stationery article of the present invention showing another embodiment in which the fastening element is formed by at least two individual pieces.

### DETAILED DESCRIPTION OF THE INVENTION

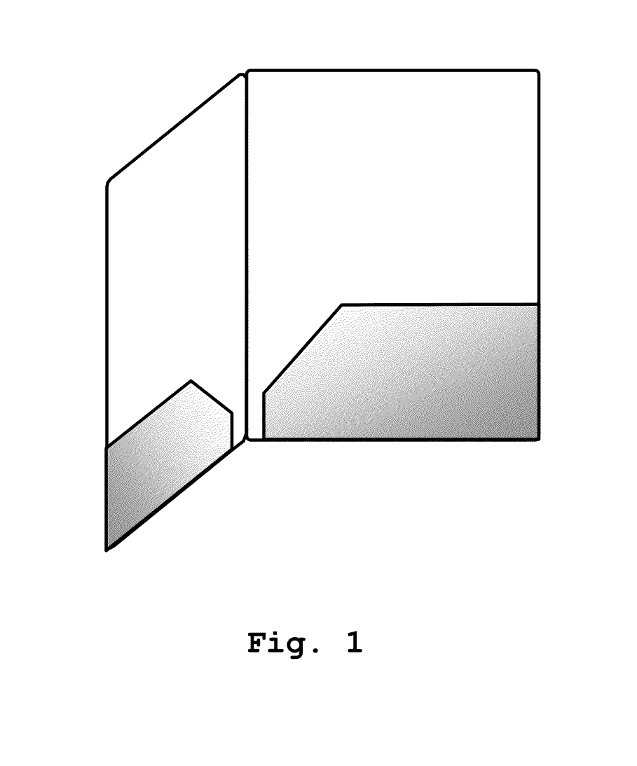

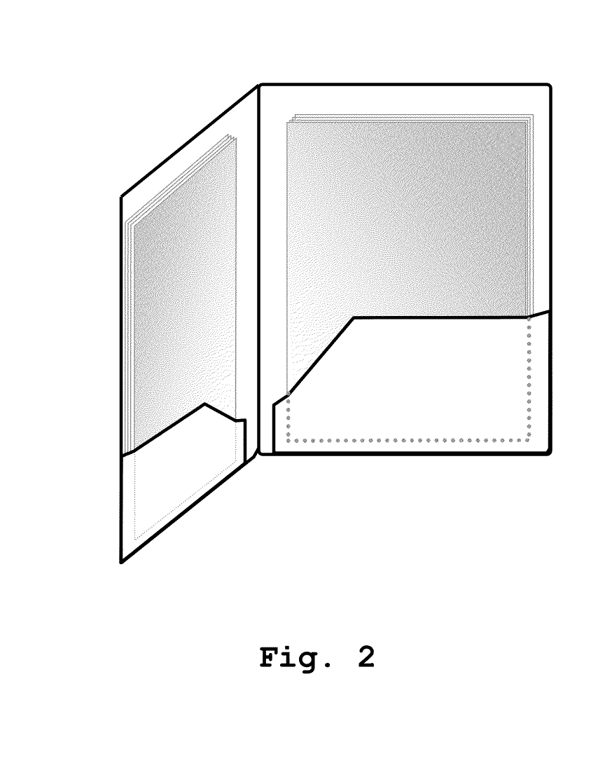

Referring to FIG. 1, there is shown the conventional portfolio or stationery article of the prior art. The stationery article 1 has a front panel 2 and back panel 3. There are lapels 4 that are attached to one or both of the internal surfaces of the front panel 2 and the back panel 3 The lapels are bonded through well known processes of the prior art, such as welding, ultraviolet radiation, ultrasound, gluing, bonding, thermo-sealing, sewing, etc. The area of the union between the lapel 4 and the interior surface of the front panel 2 and the back panel 3 is normally reduced to a narrow strip located along the inferior edge of the panels and the corresponding part next to the end for which the portfolio is open. As such, it forms a type of “pocket” or support in order to maintain the inferior end of one or several pages of a document 5 so as to be preserved within the interior of the article 1, as is illustrated in FIG. 2.

It should be noted that the upper end of the document normally has free movement toward the front and back, as indicated by the double-headed arrow, with respect to the front panel 2 or the back panel 3. This movement is subject to restriction solely by means of mechanical action applied directly to the document. This would include additions such as staples, paper clips, or fasteners. These maintain the group of pages of the document to a certain extent. However, they do not protect, in any way, the edges and corners of the documents of the top thereof.

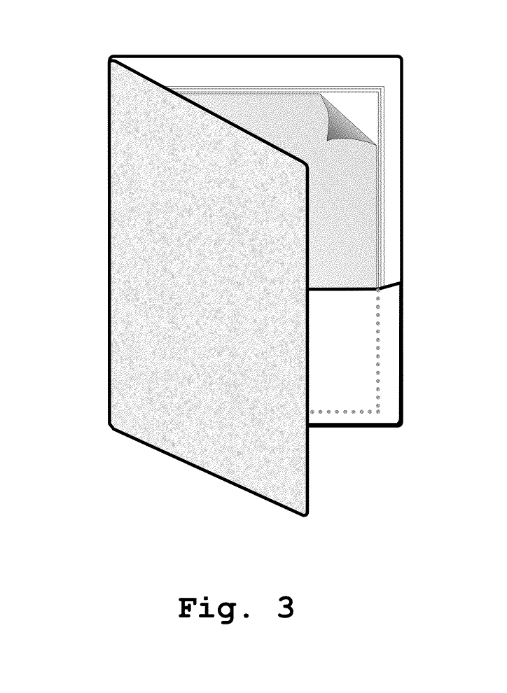

With reference to FIG. 3, the panels are shown as closing one on another. This is indicated by the arrow at the inferior part of the illustrated portfolio. It is possible that the edges or corners of the documents in the interior of the portfolio could move toward the front in order to remain pressed between the panels of the portfolio. This will cause the pages to suffer a wrinkle or a bend. As such, the document can be tarnished. This action is indicated by the curved area and the indication of bending in the upper-right corner of the document 5, as shown in FIG. 3.

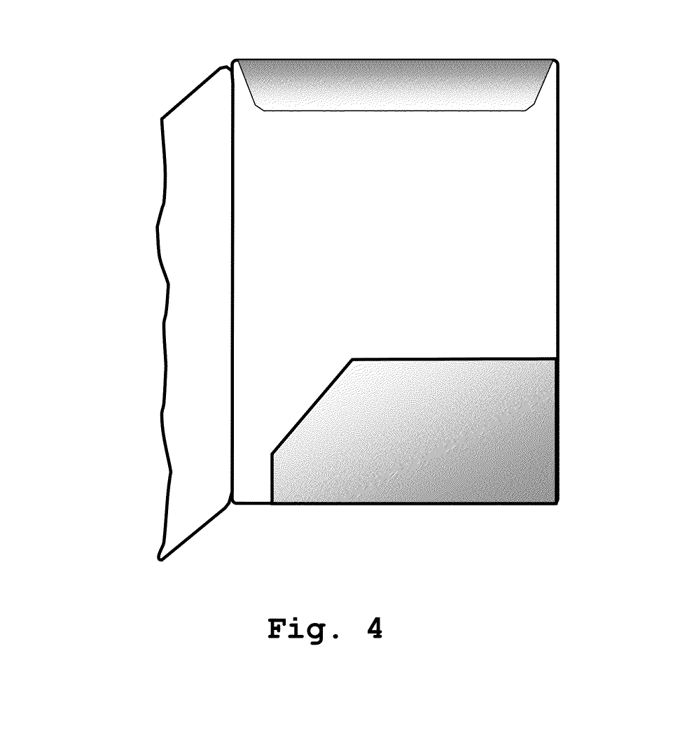

In order to solve the problems associated with the upper edges of the documents in the corners of the documents, along with the bending toward the front because of the free movement provided, the present invention provides a fastening element 6, as shown in FIG. 4. Fastening element 6 includes a ribbon of flexible or semi-flexible material. This ribbon can be of transparent, semi-transparent, translucent, or colored plastic material.

The fastening element 6, in the preferred embodiment the present invention, has a trapezoidal shape, and a larger base that is equal to or slightly less than the interior length of the front panel 2 or the back panel 3 taken along the upper edge. The fastening element 6 is located opposite to the location of the lapel or pocket. The fastening element 6 is anchored to the upper edge of the interior surface of the front panel 2 or the back panel 3. The lapel or pocket is shown located in the lowest portion of the panel. The anchoring of the fastening element 6 is carried out by means of any well-known technique of the art, such as ultraviolet radiation, welding, ultrasound, bonding, thermo-sealing, sewing, etc. The fastening element 6 conforms the body of the panels of the stationery article for the preservation of documents. The materials of the fastening element 6 should be compatible with the materials of the stationery article in order to assure the fixation of the fastening element to the stationery article.

The minor base of the trapezoidal shape of the fastening element 6 goes toward the center of the panel. The fastening element 6 has rounded corners. These rounded corners avoid any rip or scratch to the papers that are preserved within the folder or portfolio.

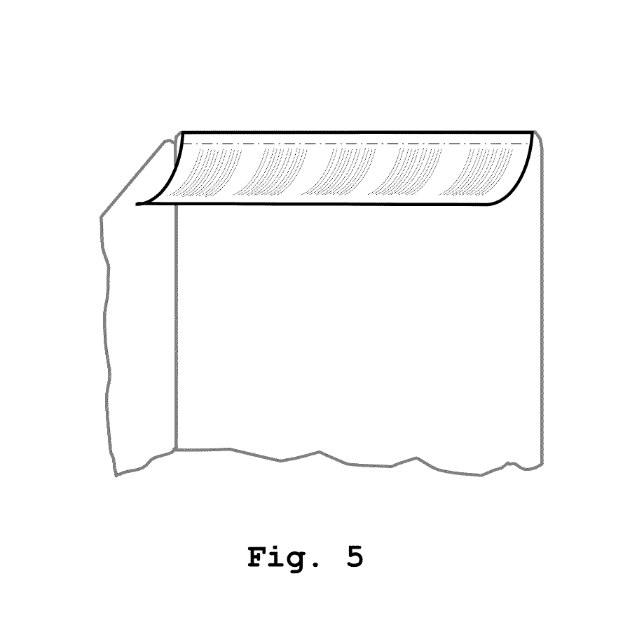

The union area between the fastening element 6 and the interior surface of the panel of the stationery article is located in the most external portion of the surface of the fastening element 6 and that of the front panel 2 or the back panel 3. It is limited approximately in accordance with the A-A line, as shown in FIG. 5. The higher or lower rigidity of the selected material serves to produce the fastening element 6 and permits the element to always be in contact with the interior surface of the panel to which it is united. As such, during its position of non-use, as shown in FIG. 4 herein previously, the fastening element 6 does not interfere with the documents that are inserted into the portfolio. As such, it allows users to use the portfolio in a conventional way.

With reference to FIG. 5, the fastening element becomes operative when the documents have been inserted into the lapel or pocket 4. The inferior edge of the fastening element 6 (i.e. the minor base of the trapezoidal shape) is bent upward in the opposite direction to the interior surface of the panel, as shown in FIG. 5 by the arrows. This permits the insertion of the upper edge of the documents 5 underneath the fastening element 6. As such, the documents will be located between the fastening element and the interior surface of the front panel 2 or the back panel 3 of the folder of the present invention.

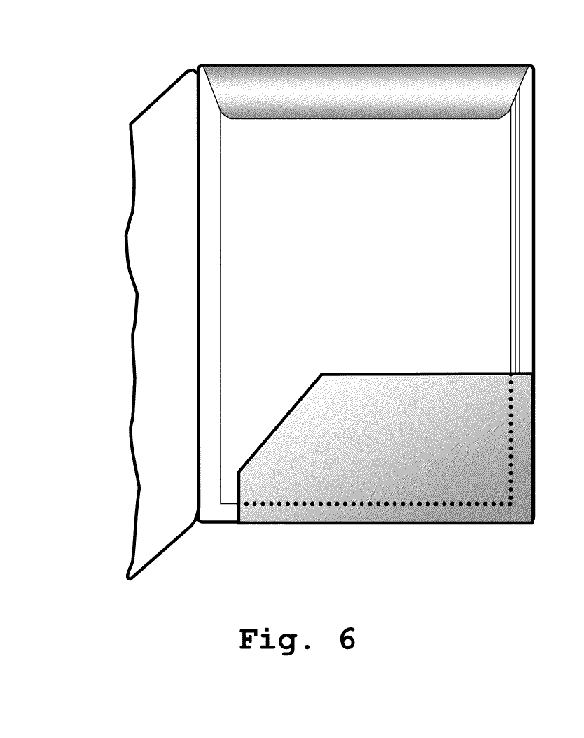

Upon releasing the fastening element 6, the fastening element will return to its normal position. This is the result of its relative rigidity and of the location of the area of the union with the interior surface of the panel of the portfolio. The fastening element has an upper edge that is bonded slightly below the upper edge of the panel. The fastening element 6 exerts a pressure against the document toward the internal surface of the panel of the stationery article. As such, the upper edge of the documents 5 will be trapped in the manner illustrated in FIG. 6. This serves to reduce substantially the capability of movement of the front pages and avoids the possibility of folding the front pages upon opening the stationery article.

If the material used for the fastening element is transparent, then the element 6 will not interfere with the possibility of viewing the content on the front page or cover of the document 5. Additionally, this feature is enhanced by the fact that the width of the fastening element 5 is substantially less than the entire area of the document and substantially less than the surface of the back panel 3 of the stationery article. As such, the document can be easily read through the space between the fastening element and the pocket.

Within the concept of the present invention, the fastening element can be made on one or both of the interior surfaces of the panels. Such a fastening element can also be used in association with a portfolio having rings or hoops, along with other fasteners. Importantly, the fastening element 6 does not interfere with the normal operation of any of these types of articles to which it could be attached.

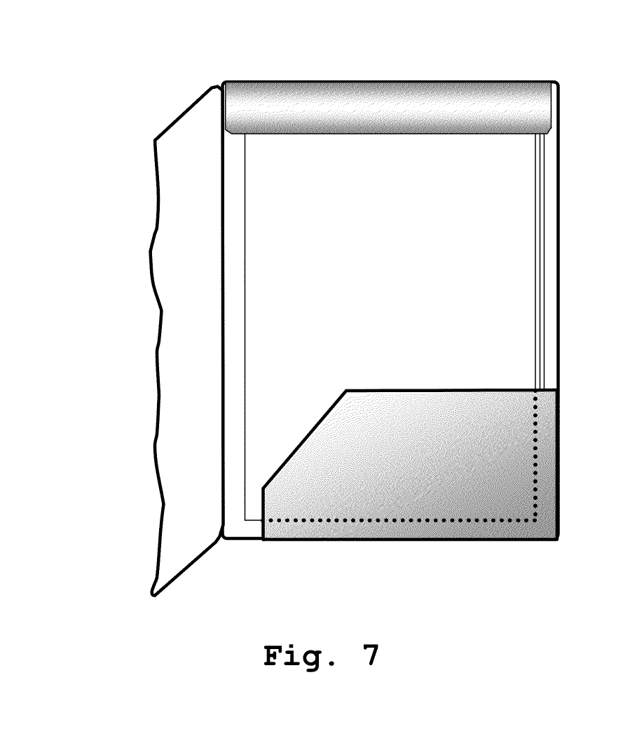

In another embodiment of the present invention, as illustrated in FIG. 7, the fastening element 6 can have a rectangular shape, instead of a trapezoidal shape. This can maintain the characteristic or having the corners adjacent to the inferior edge rounded in order to avoid ripping of the documents contained within the stationery articles.

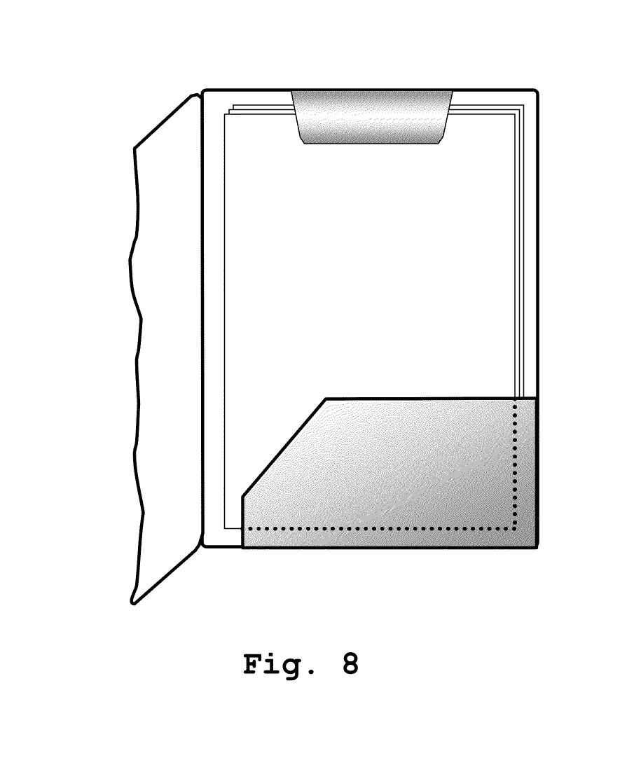

In still another embodiment of the present invention, as illustrated in FIG. 8, the fastening element 6 can have a longitudinal dimension substantially less than that of the width of the panel of the portfolio to which is attached. As such, the fastening element 6 can still maintain the documents between the fastening element 6 and the surface of the panel, along with protecting the edge of the documents upon which it is positioned thereover. The protection of the edge of the document is restricted due to the fact that the area of the upper edge is anchored to the panel of the portfolio. It is possible to protect any of the corners of the document if the fastening element 6 is anchored to the panel in a proximal way to the selected corner. In another case, the fastening element can be located as centered relative to the panel.

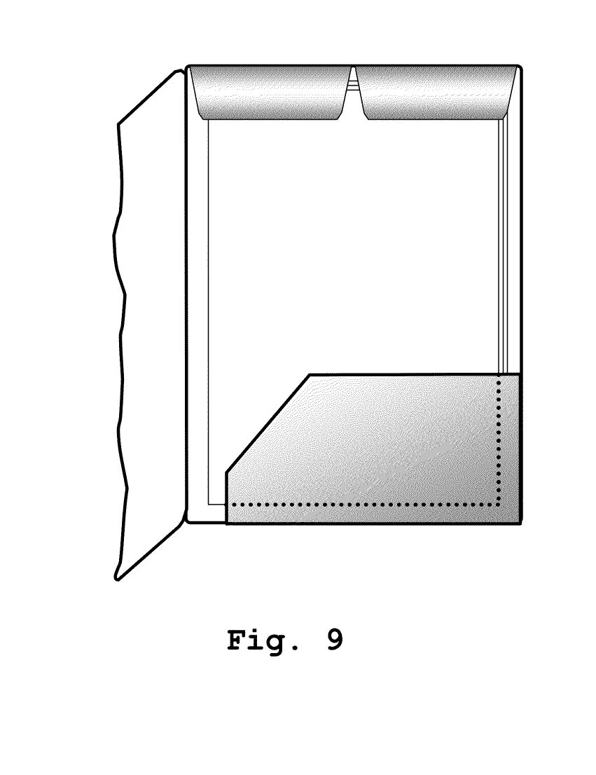

In another embodiment the present invention, as illustrated in FIG. 9, the fastening element 6 is divided into two or more sections along the longitudinal length thereof. This offers flexibility to the respective panel of the portfolio while still maintaining the characteristics associated with the protection of the upper edge of the document and of the corners of the documents. By including several elements for the formation of the fastening element 6, it is possible to save material while achieving the same functionality.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A stationery article for the preservation of documents, the stationery article comprising:
a body suitable for holding documents, said body having a first panel in foldable relationship with a second panel, said first panel having a lower edge and an upper edge with a side edge extending between said upper edge and said lower edge, said first panel having a generally planar surface;
a sheet affixed directly to said lower edge and directly to said side edge so as to define a pocket with said generally planar surface of said first panel, said sheet being formed of a flexible material, said sheet extending from said lower edge of said first panel toward said upper edge of said body for a distance less than one-half of a distance between said lower edge and said upper edge of said first panel, the pocket suitable for holding documents against said generally planar surface of said first panel; and
a trapezoidal-shaped fastening element formed of a single ribbon of semi-rigid material, said fastening element having an upper portion adhered directly to said first panel at a location inwardly of said upper edge of said first panel, said fastening element having a lower portion biased toward and free of said generally planar surface of said first panel and flexibly movable away from said generally planar surface, said fastening element suitable for holding an upper portion of the documents against said generally planar surface, said lower portion of said fastening element having a linear edge in parallel relation to said upper edge of said first panel, said linear edge of said lower portion of said fastening element having a length less than a length of an linear edge of said upper portion of said fastening element, said generally planar surface of said first panel being uncovered in an area between said fastening element and said sheet when documents are not positioned thereon, said fastening element having an uninterrupted surface without a fold line extending between the linear edges thereof, said fastening element being of a transparent or translucent material, said fastening element lying juxtaposed against said generally planar surface of said first panel, said fastening element suitable for preventing the documents from moving when interposed between said fastening element and said generally planar surface, said side edge having no fastening element extending inwardly therefrom, said fastening element being entirely uncovered on a surface thereof opposite said first panel.
